(19) United States
(12) Patent Application Publication
(10) Pub. No.: US 2010/0329510 A1
(43) Pub. Date: Dec. 30, 2010

(54) METHOD AND DEVICE FOR DISPLAYING THE SURROUNDINGS OF A VEHICLE

(76) Inventor: Roland Schmid, Stuttgart (DE)

Correspondence Address: KENYON & KENYON LLP, ONE BROADWAY, NEW YORK, NY, 10004, US

(21) Appl. No.: 12/735,164

(22) PCT Filed: Nov. 10, 2008
(86) PCT No.: PCT/EP2008/065239

§ 371 Date: Sep. 3, 2010

(30) Foreign Application Priority Data
Jan. 9, 2008 (DE) 10 2008 003 662.5

(51) Int. Cl. G06K 9/00; G08G 1/04; H04N 7/18

(52) U.S. Cl. 382/103; 340/943; 348/148; 348/E07.085

(57) ABSTRACT

In a method for displaying on a display device the surroundings of a vehicle, the surroundings are detected by at least one detection sensor as an image of the surroundings while the vehicle is traveling or at a standstill. A surroundings image from a given surrounding area is ascertained by the detection sensor in different vehicle positions, and/or at least one surroundings image from the given surrounding area is ascertained by each of at least two detection sensors situated at a distance from one another, and in each case a composite surroundings image is obtained from the surroundings images and displayed by the display device.

### BACKGROUND OF THE INVENTION

1. Field of the Invention

The present invention relates to a method and device for displaying the surroundings of a vehicle, in particular a motor vehicle, using at least one display device of the vehicle, the surroundings being detected by at least one detection sensor as an image of the surroundings while the vehicle is traveling or at a standstill.

2. Description of Related Art

Methods and devices of the aforementioned type are known from the related art. These methods and devices are often used in conjunction with parking assistance systems of motor vehicles, in which, in order to simplify the parking operation, the immediate surroundings are displayed to the driver, via a colored display of the critical distances from the vehicle, on a display device of the vehicle. For this purpose the immediate surroundings of the vehicle are detected using a detection sensor, only the objects or contours of these objects detected at the moment in the area in front of and/or behind the vehicle which are directly detected by the one or multiple detection sensors being displayed. In particular, only the closest object, but not an object behind this closest object, is displayed or detected. Published German Patent Application DE 10 2004 027 640 A1 discloses such a method and such a device, in which a parking space is measured with the aid of the detection sensor during travel of the vehicle while driving past the parking space, so that a schematic surroundings image of the contour of the parking space may be obtained. Furthermore, Published German Patent Application DE 197 41 896 A1 discloses a device for displaying the surroundings of a vehicle of the type mentioned at the outset, having a (video) camera via which distance information concerning recorded image points may also be transmitted to the control unit, as the result of which the surroundings of the vehicle displayed on a display unit may represent not only the closest objects, but also objects situated behind same. However, this requires high computational power, and also allows only the surroundings image/range of the surroundings detected by the camera at the moment to be displayed.

### BRIEF SUMMARY OF THE INVENTION

The method according to the present invention provides that in each case a surroundings image from a given surrounding area is ascertained by the detection sensor in different vehicle positions, and/or at least one surroundings image from the given surrounding area is ascertained in each case by at least two detection sensors situated at a distance from one another, in each case a composite surroundings image being obtained from the surroundings images and displayed by the display device. Thus, on the one hand it is provided that a surroundings image from a given surrounding area is ascertained in each case in different vehicle positions, for example while driving the vehicle, using a detection sensor. Due to the fact that the given surrounding area is detected from two different vehicle positions with the aid of the detection sensor, the surrounding area is “observed” from different angles/perspectives, thus generating different surroundings images which record the surrounding area from different sides. A composite surroundings image is then obtained from these images by combining the information which may be extracted from the particular surroundings images to form a surroundings image. By observing the surrounding area from different viewing angles it is thus possible to detect not only the closest objects, but also objects situated behind same, and to accordingly display these using the display device of the vehicle. Alternatively or additionally, it is provided that when the vehicle is at a standstill or is traveling, surroundings images from the given surrounding area are detected from different “viewing angles,” using at least two detection sensors situated at a distance from one another. This has the same effect as the above-described detection of the surrounding area from two different vehicle positions using one detection sensor, for example while driving. The use of multiple detection sensors has the advantage that the composite surroundings image combined from the surroundings images may be obtained even when the vehicle is at a standstill. In addition, the composite surroundings image may be obtained much more quickly, since the given surrounding area may be simultaneously detected from different perspectives. With the aid of multiple detection sensors it is also possible to easily display the instantaneous surroundings of the vehicle, including the closest objects as well as objects situated behind same. The composite surroundings image advantageously results in a surroundings map which illustrates the surroundings of the vehicle with particular accuracy of detail, preferably in a top view of the vehicle.

According to one refinement of the present invention an ultrasonic sensor is used as the detection sensor. Ultrasonic sensors are preferably used for all the detection sensors of the vehicle. Ultrasonic sensors represent the related art in currently known parking assistance systems, so that on the one hand a more detailed description is not necessary here, and on the other hand it is clear that such detection sensors may be used in a simple and cost-effective manner. Using an ultrasonic sensor, it is possible in particular to directly detect or ascertain the distance from an object. In addition, contours of the object in the detection range may be detected and ascertained using multiple ultrasonic sensors.

Alternatively, it is provided that a short-range radar sensor, a LIDAR sensor, or a so-called range imager is used as the detection sensor. If multiple detection sensors are provided, it is also possible to use a combination of the above-referenced detection sensors.

The speed, the steering angle, and/or the yaw angle of the vehicle is/are advantageously taken into account in obtaining the composite surroundings image or the surroundings map. In this way the surroundings images detected by the detection sensor or the detection sensors may be unambiguously oriented in a coordinate system in relation to the vehicle and appropriately combined. For obtaining a composite surroundings image while driving the vehicle, it is advantageous that objects located in the surroundings laterally to the vehicle may likewise be detected and taken into account by a door opening assistance system, for example, so that after a parking operation a driver is notified, for example, that a given door should not be opened because there is a risk of collision with an object situated nearby. In the simplest case, a detection sensor mounted on the door would be necessary for such a door opening assistance system. However, this may be dispensed with using the method according to the present invention, since the composite surroundings image represents the surroundings of the vehicle, not just the surrounding area detected at the moment.

The speed, the steering angle, and/or the yaw angle of the vehicle is/are advantageously detected using sensors which preferably are already present in the vehicle. This allows the speed, the steering angle, and/or the yaw angle to be determined in a particularly cost-effective manner.

The speed is advantageously detected using one or multiple speed sensors.

It is advantageously provided that at least one detection sensor is oriented essentially perpendicularly to the longitudinal axis of the vehicle. Four detection sensors are typically mounted in the front end and/or four detection sensors are typically mounted in the rear end of the vehicle, which are essentially oriented toward the front or the rear, respectively. For detecting the surroundings of the vehicle while driving, these detection sensors are also sufficient for detecting objects located laterally to the vehicle. However, when the vehicle is at a standstill it is advantageous when at least one additional detection sensor on at least one side of the vehicle is oriented essentially perpendicularly to the longitudinal axis of the vehicle. Thus, even when the vehicle is at a standstill, objects located next to the vehicle may be detected and displayed to the driver with the aid of the display device. In principle, of course, it is possible to increase the number of detection sensors used in order to obtain an even more detailed surroundings image. Likewise, the number of detection sensors may be reduced. When ultrasonic sensors are used, the distances from objects are computed in a known manner by triangulation of neighboring sensor signals. By observing the surrounding area from different viewing angles it is possible, as previously stated, to ascertain not only distances from objects but also the shape of the objects. Thus, for example, a differentiation may be made between a continuous wall and a post, or a row of posts.

According to one refinement of the present invention, a trajectory is displayed in the composite surroundings image as a function of the instantaneous steering angle. This trajectory indicates the travel path of the vehicle along which the vehicle would move at the instantaneous steering angle. Additionally or alternatively, with the aid of the display device a setpoint trajectory is displayed as a function of the obtained surroundings image which specifies a travel path for the driver of the vehicle, for example to reach a parking position. Of course, the driver may also be made aware of objects detected by the detection sensor via acoustic and/or haptic warning signals.

Objects detected in the surroundings of the vehicle are advantageously differently identified graphically, in particular in color, as a function of their risk factor. Thus, for example, objects which do not represent an obstacle are displayed in black; objects which are recognized/detected as an obstacle but which are not located in a critical range, in green; objects which are located in a critical range but which are still far away, in yellow; objects which require an intervention by the driver to avoid a collision, in orange; and objects with which a collision is imminent, in red.

The composite surroundings image may also be advantageously used for autonomous or semi-autonomous parking operations.

According to one advantageous refinement of the present invention, the composite surroundings image is supplemented by (video) images from at least one rear view camera and/or side camera of the vehicle. Thus, the composite surroundings image/surroundings map as well as an actual video image of the surroundings or a surrounding area are available to the driver of the vehicle.

The composite surroundings image is preferably stored after a parking operation. When leaving a parking space, the stored surroundings image may be used again so that the surroundings map of the surroundings of the vehicle is available to the driver even before he has moved the vehicle. However, since the surroundings may have changed in the meantime, the stored surroundings image is advantageously compared to an instantaneous composite surroundings image to ascertain new and/or missing objects in the surroundings. This is preferably carried out when the vehicle is at a standstill, using the at least two detection sensors separated by a distance from one another, it being likewise possible to obtain the instantaneous composite surroundings image using a detection sensor, as described above.

It is further provided that new and/or missing objects are differently identified graphically, in particular in color. It is particularly preferred to display missing objects using a dashed contour line. It is likewise preferable to graphically identify, preferably in color, objects and/or surrounding areas which are not verifiable. In this case the driver of the vehicle is prompted to check these objects/surrounding areas himself.

The advantageous method for displaying the surroundings of a vehicle may be used, for example, for maneuvering in narrow roadways, driveways, or parking garages, for example.

A full panoramic display of the vehicle as a composite surroundings image is particularly preferably obtained from the surroundings images. For this purpose the detection sensors are mounted and oriented at appropriate locations on the vehicle.

The device according to the present invention for displaying the surroundings of a vehicle is distinguished in that at least one computing unit is associated with the display device which combines the surroundings images from a given surrounding area detected by the detection sensor in at least two different vehicle positions, and/or surroundings images from the given surrounding area detected by two detection sensors situated on the vehicle which are separated from one another by a distance, to form a composite surroundings image, and displays same with the aid of the display device.

At least one detection sensor is advantageously designed as an ultrasonic sensor. All of the detection sensors are particularly preferably designed as ultrasonic sensors.

At least one detection sensor is advantageously oriented essentially perpendicularly to the longitudinal axis of the vehicle. This detection sensor is particularly preferably situated in the area of a door of the vehicle or directly on the door.

It is further provided that the display device and/or the computing unit is/are connected to at least one rear view camera and/or at least one side camera.

One or multiple sensors for detecting the speed, the steering angle, and/or the yaw angle of the vehicle is/are advantageously associated with the computing unit.

### BRIEF DESCRIPTION OF THE DRAWINGS

FIGS. 1A and 1B show an example traffic situation and a composite surroundings image according to the advantageous method.

FIGS. 2A and 2B show the traffic situation at a later point in time and the corresponding composite surroundings image.

FIGS. 3A and 3B show the traffic situation at an even later point in time and a corresponding composite surroundings image.

### DETAILED DESCRIPTION OF THE INVENTION

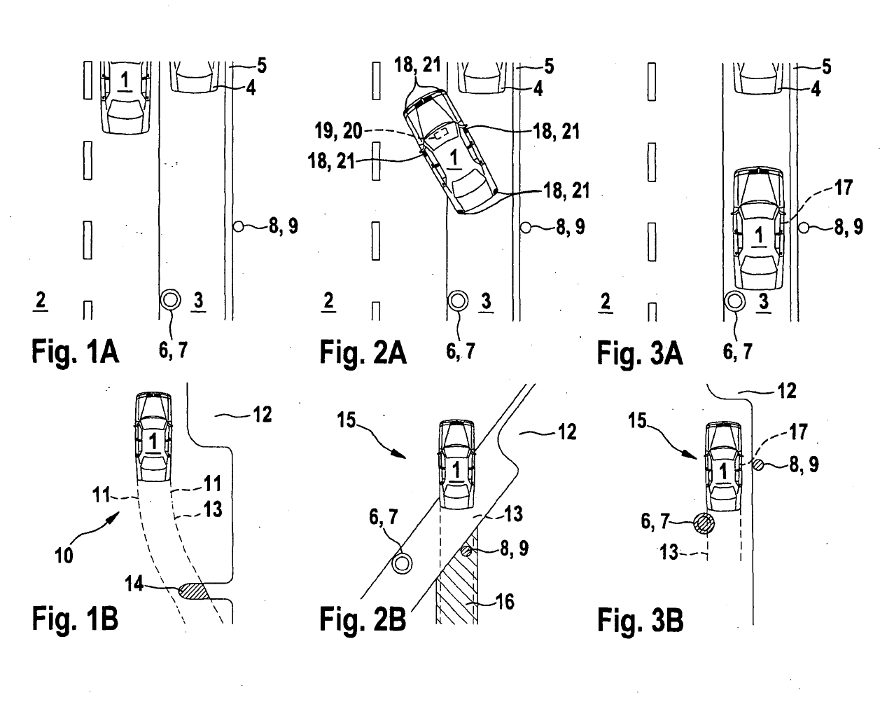

FIG. 1A shows a top view of a traffic situation with a vehicle 1 which is located on a roadway 2. On its right side, viewed in the direction of travel of vehicle 1, roadway 2 has a shoulder, i.e., a parking lane 3, on which a vehicle 4 is parked. Parking lane 3 is bordered on its right side by a curb 5. An object 6 designed as a post 7 is situated on parking lane 3, near roadway 2 and at a distance from parked vehicle 4. An object 8 designed as a pole 9, for example for a street light, is situated near curb 5 between parked vehicle 4 and post 7, on the side of curb 5 opposite from parking lane 3. The driver of vehicle 1 then intends to park in the parking space between parked vehicle 4 and post 7.

FIG. 1B shows the display of a display device for displaying the surroundings of vehicle 1. A surroundings image 10 from a given surrounding area of vehicle 1 is ascertained in each case in different positions of vehicle 1, using a detection sensor. This may be carried out, for example, when the vehicle travels past the parking space which is present between parked vehicle 4 and post 7. For this purpose the detection sensor must be appropriately situated on vehicle 1, in particular perpendicular to the longitudinal axis of vehicle 1. Additionally or alternatively, at least one surroundings image from the given surroundings is ascertained in each case, preferably at the same time, using at least two detection sensors which are mounted on vehicle 1 and separated from one another by a distance. In each case a composite surroundings image 10 is obtained from the surroundings images of the one detection sensor or of the at least two detection sensors, as illustrated in FIG. 1B, and is displayed using the display device. Surroundings image 10 shows vehicle 1 in a top view, i.e., a so-called bird's eye view. Dashed lines 11 represent a vehicle path or trajectory 13 which indicates the path vehicle 1 would travel during a backing motion at an instantaneous steering angle. The surroundings of vehicle 1 are illustrated only schematically in FIG. 1B, the same as in the related art, the contours of the closest objects or obstacles being indicated. An obstacle range 12 composed of vehicle 4, curb 5, and post 7, as illustrated in FIG. 1A, is advantageously displayed as a contiguous area in yellow. A projecting section of the range which takes post 7 into account is intersected by trajectory 13 and therefore is situated in the vehicle path, i.e., on a collision course with vehicle 1. This overlap area 14 is therefore advantageously displayed in another color, preferably orange. However, using the advantageous method as described above allows even greater accuracy of detail of the representation or display of the surroundings of vehicle 1. This is explained in greater detail with reference to FIGS. 2A through 3B.

FIG. 2A shows the traffic situation from FIG. 1A at a later point in time at which the driver has moved vehicle 1 backward at an angle into the parking space between vehicle 4 and post 7. Vehicle 1 is then partially in the parking space. FIG. 2B shows a composite surroundings image 15 obtained according to the advantageous method. Vehicle 1 is illustrated in a top (bird's eye) view. Using the advantageous method, the shape of object 6, i.e., post 7, may be ascertained by observing from different perspectives, and may be displayed as illustrated in FIG. 2B. Thus, object 6 is displayed separately from obstacle range 12 illustrated in FIG. 1B. FIG. 2B shows remaining obstacle range 12 with the exception of object 6; at this point pole 9, i.e., object 8, located on the other side of curb 5 is also displayed. Object 8 is likewise advantageously displayed in orange, since although it is located in the instantaneous vehicle path or in the instantaneous trajectory 13, the distance from vehicle 1 is not yet critical. Likewise, overlap area 16 in surroundings image 15 which intersects with trajectory 13 is identified in color. The driver is then able to distinguish between closest objects and objects situated behind same, and is also able to recognize the shape of objects. This is possible as a result of the advantageous combination, described above, of the surroundings images detected from the particular surrounding area. Ultrasonic sensors are advantageously used as detection sensors. For this purpose, detection sensors 18 and a display device 19 which displays composite surroundings image 15 are shown for purposes of illustration in FIG. 2A. A computing unit 20 which combines the surroundings images is integrated into display device 19.

FIG. 3A shows the traffic situation from preceding FIGS. 1A and 2A at an even later point in time at which vehicle 1 is in a parking position in the parking space between vehicle 4 and pole 7. Vehicle 1 is situated with its rear end near post 7, i.e., object 6, and with a passenger door 17 at the level of object 8, i.e., pole 9.

FIG. 3B shows surroundings image 15 corresponding to the traffic situation illustrated in FIG. 3A at the even later point in time. Object 8 and object 6 are displayed in red, since they are very close to the vehicle, i.e., in a critical range. Due to the proximity to the vehicle the risk factor of the vehicle is increased, and therefore the color is changed from the previously noncritical orange to red. Object 6, i.e., post 7, is therefore displayed in red, i.e., is detected as a high risk, since the object/post is present in instantaneous trajectory 13, i.e., in the path of vehicle 1. On the other hand, object 8, i.e., pole 9, has a high risk because the object/pole is close to passenger door 17. For this reason, with the aid of the display or composite surroundings image 15 the driver and/or the passenger should be made aware that door 17 should not be opened or is not openable. As a safety measure it is possible to automatically lock door 17, or, using haptic and/or acoustic signals, to make the driver and/or the passenger aware of the risk posed by object 8. It is also possible for the door to be openable only to the extent that it does not collide with object 8, i.e., pole 9.

Via composite surroundings image 15 (dynamic two-dimensional image) which represents a surroundings map of the entire immediate surroundings of the vehicle, a driver of vehicle 1 may be visually assisted, in particular during parking operations or when maneuvering in tight spaces. The steering angle, the yaw angle, and/or the speed of the vehicle is/are advantageously detected for positioning the detected obstacles/objects with respect to vehicle 1 on display device 19. Based on the information provided to him by the display, the driver may easily avoid collisions and/or hazards while maneuvering and/or parking. Composite surroundings image 15 ascertained for parking is advantageously stored and reused for leaving the parking space. Verification and plausibility checking should advantageously be carried out by detecting the surroundings once more. Vehicle 1 is typically provided with ten or twelve ultrasonic sensors, four detection sensors or ultrasonic sensors being provided at the front end and four detection sensors being provided at the rear end of the vehicle as the basis of a standard parking assistance system. It is also advantageous to provide at least one detection sensor on each side of the vehicle. In principle, however, the number of rear, front, and lateral detection sensors may be varied. The accuracy of detail of the surroundings image is improved with increasing numbers of detection sensors. Overall, as the result of detecting a given surrounding area of the surroundings from different perspectives, the advantageous method allows determination of the shape of objects, as well as detection of multiple objects situated one behind the other (multiple target capability). With reference to the present exemplary embodiment of FIGS. 1A through 3B, the surroundings of vehicle 1 are advantageously divided into multiple different adjoining or partially overlapping surrounding areas, the division being a function of the configuration, number, and orientation of the detection sensors, and after detecting the particular surrounding area from different perspectives the surroundings images are then combined to form the composite surroundings image.

1-20. (canceled)

21. A method for displaying the surroundings of a vehicle on a display device, comprising:
performing at least one of the following detection steps (a) and (b):
(a) detecting, using at least one detection sensor, an image of a selected surrounding area of the vehicle in each of at least two different vehicle positions; and
(b) detecting, using each one of at least two detection sensors situated at a distance from one another, a respective image of the selected surrounding area;
generating a composite surrounding image from at least one of (i) the detected images in step (a) and (ii) the detected images in step (b); and
displaying the composite surrounding image on the display device.

22. The method as recited in claim 21, wherein the detection sensors are ultrasonic sensors.

23. The method as recited in claim 21, wherein the detection sensors are one of a short-range radar sensor, a LIDAR sensor, or a range imager.

24. The method as recited in claim 21, wherein at least one of speed, steering angle, and yaw angle of the vehicle is taken into account in obtaining the composite surrounding image.

25. The method as recited in claim 24, wherein the speed is detected using at least one wheel speed sensor.

26. The method as recited in claim 24, wherein the at least one detection sensor used in step (a) is oriented substantially perpendicularly to the longitudinal axis of the vehicle.

27. The method as recited in claim 24, wherein a trajectory of the vehicle is displayed in the composite surrounding image as a function of the instantaneous steering angle of the vehicle.

28. The method as recited in claim 24, wherein different objects detected in the selected surrounding area are differently identified graphically as a function of a risk factor.

29. The method as recited in claim 24, wherein the composite surrounding image is used for one of autonomous or semi-autonomous parking operation.

30. The method as recited in claim 24, wherein the composite surrounding image is supplemented by images from at least one of rear view camera and a side camera.

31. The method as recited in claim 30, wherein the composite surrounding image is stored after a parking operation.

32. The method as recited in claim 31, wherein the stored composite surrounding image for the selected surrounding area is subsequently compared to a later composite surrounding image for the selected surrounding area to ascertain differences including at least one of new objects and missing objects.

33. The method as recited in claim 32, wherein the ascertained differences are graphically identified in color.

34. The method as recited in claim 32, wherein the stored composite surrounding image is supplemented with the ascertained differences including at least one of new objects and missing objects and subsequently used for leaving a parking space.

35. A system for displaying the surroundings of a vehicle, comprising:
a detection sensor suite including at least two detection sensors configured to perform at least one of the following detections (a) and (b):
(a) detecting, using at least one detection sensor, an image of a selected surrounding area of the vehicle in each of at least two different vehicle positions; and
(b) detecting, using each one of at least two detection sensors situated at a distance from one another, a respective image of the selected surrounding area;
a computing unit configured to generate a composite surrounding image from at least one of (i) the detected images in detection (a) and (ii) the detected images in detection (b); and
at least one display device configured to display the composite surrounding image.

36. The system as recited in claim 35, wherein the detection sensors are ultrasonic sensors.

37. The system as recited in claim 35, wherein the detection sensors are one of a short-range radar sensor, a LIDAR sensor, or a range imager.

38. The system as recited in claim 37, wherein the at least one detection sensor for detection (a) is oriented substantially perpendicularly to the longitudinal axis of the vehicle.

39. The system as recited in claim 37, wherein at least one of the display device and the computing unit is connected to at least one of a side-view camera and a rear-view camera.

40. The system as recited in claim 39, further comprising at least one wheel speed sensor for detecting the speed of the vehicle, wherein the speed of the vehicle is taken into account in obtaining the composite surrounding image.
